(19) United States
(12) Patent Application Publication
(10) Pub. No.: US 2019/0015850 A1
(43) Pub. Date: Jan. 17, 2019

(54) NOZZLE FOR SPRAYING LIQUID MEDIA

(71) Applicants: Nathan ENGELS, Reutlingen (DE); Robert HEINKEL, Dettingen/Erms (DE)

(72) Inventors: Nathan ENGELS, Reutlingen (DE); Robert HEINKEL, Dettingen/Erms (DE)

(21) Appl. No.: 16/032,224

(22) Filed: Jul. 11, 2018

(30) Foreign Application Priority Data
Jul. 14, 2017 (DE) 10 2017 212 139.4

(51) Int. Cl. B05B 1/32; B05B 1/30

(52) U.S. Cl. CPC B05B 1/323; B05B 1/3006

(57) ABSTRACT

The invention relates to a nozzle for spraying liquid media, in particular plant protection agents and liquid fertilizers, having a housing, wherein the housing has at least one liquid inlet, an outlet chamber and at least one outlet opening in fluid connection with the outlet chamber, in which a valve of variable flow resistance is arranged between the liquid inlet and the outlet opening, wherein the flow resistance of the valve is dependent on the liquid pressure.

### CROSS-REFERENCE TO RELATED APPLICATIONS

This claims priority from German Patent Application No. 10 2017 212 139.4, filed on Jul. 14, 2017, the disclosure of which is hereby incorporated by reference in its entirety.

### TECHNICAL FIELD

The invention relates to a nozzle for spraying liquid media, in particular plant protection agents and liquid fertilizers, having a housing, wherein the housing has at least one liquid inlet, an outlet chamber and at least one outlet opening in fluid connection with the outlet chamber.

### BACKGROUND OF THE INVENTION

Nozzles are generally supplied with a liquid medium at constant pressure. At a predefined pressure, there is then a predefined volume of liquid medium which is dispensed from the nozzle. In agriculture, it is often useful to dispense different quantities of liquid medium. For example, it is determined by suitable sensors or by observation that part of a field requires more liquid fertilizer, whereas another part requires less liquid fertilizer. In the case of conventional nozzles, the volume dispensed can be adjusted by way of the pressure of the liquid medium. However, the change in the volume dispensed is not proportional to the change in pressure since approximately four times the pressure is required to double the volume dispensed.

### SUMMARY OF THE INVENTION

The invention is intended to improve a nozzle for spraying liquid media in respect of variability of the liquid quantity dispensed.

According to the invention, this purpose is served by providing a nozzle for spraying liquid media, in particular plant protection agents and liquid fertilizers, having a housing, wherein the housing has at least one liquid inlet, an outlet chamber and at least one outlet opening in fluid connection with the outlet chamber, in which a valve of variable flow resistance is arranged between the liquid inlet and the outlet opening, wherein the flow resistance of the valve is dependent on the liquid pressure.

Through the provision of a valve with a variable flow resistance, in particular with a variable passage cross section, the liquid volume dispensed by the nozzle can be influenced to a greater extent by way of the pressure of the liquid to be sprayed than with a constant flow resistance or passage cross section. In particular, it is possible to achieve an almost proportional dependence of the liquid quantity dispensed on the liquid pressure. As a result, it is possible, with the nozzle according to the invention, to achieve a greater change in the liquid quantity dispensed with a moderate increase in pressure than in the case of conventional nozzles. Therefore, the nozzle according to the invention is particularly suitable for agricultural engineering and especially for dispensing liquid fertilizers or plant protection agents.

According to the invention, the valve has a spring disc, wherein the spring disc can be subjected to the liquid medium to be sprayed.

In this way, a flow resistance or passage cross section of the valve can be influenced in a simple manner. In this arrangement, the spring disc does not necessarily have to delimit the passage cross section of the passage opening itself, it being sufficient if the spring disc causes a deflection downstream of the passage opening, for example, wherein this deflection is then dependent on the liquid pressure. As a result, the flow through the valve is throttled to a greater or lesser extent by the spring disc and thus the flow resistance of the valve is changed. The spring disc can be of flat or curved design. The material characteristics of the spring disc, specifically the selected material for the spring disc, together with the thickness of the spring disc and, as required, the radius of curvature thereof are variable parameters to control a volume flow through the nozzle as a function of the pressure applied.

As a development of the invention, an orifice plate having at least one passage opening is arranged in the outlet chamber, wherein the spring disc is arranged in the region of a downstream end of the passage opening. The number and size of the passage openings in the orifice plate are variable parameters to control the volume flow through the nozzle as a function of the pressure applied.

The spring disc is advantageously secured on a downstream side of the orifice plate and is arranged after the downstream end of the passage opening, when viewed in the flow direction through the passage opening.

Even if, therefore, the spring disc is not arranged in the passage opening itself and also does not change the passage cross section of the passage opening, the spring disc nevertheless forms a flow resistance for the liquid flowing through the passage opening. Depending on the position of the spring disc and thus on the angle of the deflection of the liquid by the spring disc, the flow resistance of the passage opening is thus influenced in combination with the deflection by the spring disc, and the liquid quantity flowing through the valve can be influenced. Ultimately, the spring disc thus influences the free passage cross section of the entire valve. The spring disc can be flat and can close the passage opening in the unpressurized state. At a predefined pressure, dependent on the spring constant, the spring disc is then deflected and partially or completely opens the passage opening. However, the spring disc can also be arranged at a short distance from the passage opening, thus allowing flow through the passage opening even in the unpressurized state. At a relatively high pressure, the spring disc is deflected and the flow resistance is reduced.

As a development of the invention, the spring disc has a curved shape, wherein a convex side of the spring disc faces the downstream end of the passage opening.

The spring disc thus never closes the passage opening completely but, as a result, can be mounted in a very simple manner downstream of the passage opening. The liquid flowing through the passage opening then strikes the convex side of the spring disc and, depending on the liquid pressure applied, the spring disc is deflected to a greater or lesser extent, with the result that the flow resistance obtained changes. In the relaxed state and without liquid flowing through the nozzle acting on the spring disc, the spring disc can be spaced from the downstream end of the at least one passage opening.

As a development of the invention, the spring disc is a metallic disc.

By means of metallic discs, in contrast to elastic rubber discs or sealing discs, essentially higher rigidity values may be achieved, which is advantageous for use in the nozzle according to the invention.

As a development of the invention, an outer edge of the spring disc projects freely into the outlet chamber. As a result, an outer edge of the spring disc is not clamped and, consequently, the spring disc can be moved by the liquid pressure of the liquid applied to the disc and thereby increase or reduce a flow cross section through the passage openings.

As a development of the invention, the spring disc is clamped in a central region thereof.

In this way, the outer edge of the spring disc together with the non-clamped sections of the spring disc located within the outer edge can be moved in a symmetric pattern. Furthermore, fixing of the spring disc is a simple construction and can be effected, for example, using a simple screw.

As a development of the invention, the spring disc is arranged such that the liquid medium to be sprayed is applied to the spring disc on both sides at least in sections.

In this way, the movement of the spring disc depends only on the dynamic pressure or flow pressure of the medium to be sprayed and does not depend on a static pressure within the outlet chamber or within the housing of the nozzle. Thus, any variation of the free flow cross section in the nozzle can be effected exclusively as a function of the dynamic pressure of the liquid flowing through the nozzle.

### BRIEF DESCRIPTION OF THE DRAWINGS

Further features and advantages of the invention will become apparent from the claims and the following description of preferred embodiments of the invention in conjunction with the drawings. Individual features of the different embodiments illustrated in the drawings and described in the description can be combined here in any desired manner and also without the further individual features with which they are shown or described in the context, without exceeding the scope of the invention. In the drawings:

FIG. 1 shows a section through a nozzle according to the invention in accordance with a first embodiment, and

FIG. 2 shows an enlarged illustration of detail A in FIG. 1.

### DETAILED DESCRIPTION

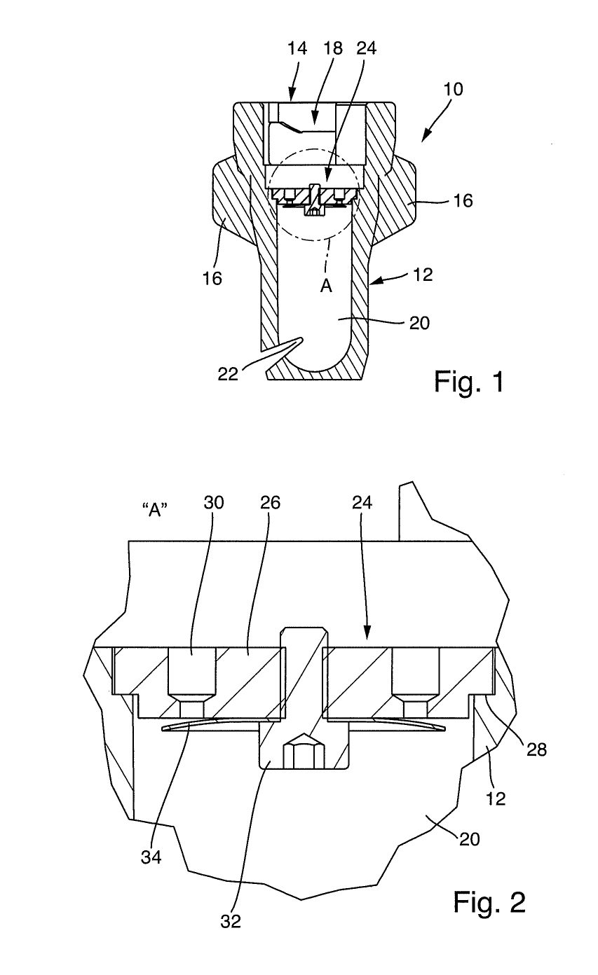

The illustration in FIG. 1 shows a nozzle 10 according to the invention, having a nozzle housing 12. The nozzle housing 12 is intended to be attached, by means of a connection structure 14 designed in the manner of a bayonet joint, to a nozzle carrier, which, in turn, is then connected to a spray line (likewise not shown). The spray line can be part of a field sprayer, for example, and different nozzles 10 are attached to the nozzle carriers on the spray line, depending on the envisaged use. To make it easier to mount the nozzle 12 on the nozzle carrier, the nozzle housing 12 is provided with grips 16.

The nozzle housing 12 furthermore has a fluid inlet 18, via which liquid medium to be sprayed flows into the nozzle housing 12. Via the liquid inlet 18, the liquid to be sprayed enters an outlet chamber 20, which is then provided with an outlet opening 22. Via the outlet opening 22, the liquid to be sprayed can then enter the environment in the form of a spray jet.

Arranged in the outlet chamber is a valve 24, which changes a flow resistance in accordance with a pressure of the liquid to be sprayed. It is thereby possible to achieve a greater dependence of the liquid quantity dispensed on the pressure of the liquid to be sprayed than would be the case with conventional spray nozzles without the valve 24. More specifically, an approximately proportional dependence of the liquid quantity dispensed on the liquid pressure can be achieved.

As can be seen from FIG. 2, the valve 24 has an orifice plate 26, which rests on an encircling shoulder 28 of the valve housing 12 and is arranged in the outlet chamber 20. The valve 24 thereby divides the outlet chamber 20 into a part situated upstream of the valve 24 and a part situated downstream of the valve 24.

The orifice plate 26 has a total of four passage openings 30, of which only two are visible in FIG. 2. The passage openings 30 are uniformly spaced apart in the circumferential direction and the central longitudinal axes thereof lie on a circular line. The passage openings 30 each have a cylindrical entry section, a taper in the form of a frustoconical section and a cylindrical exit section, which then has a smaller diameter than the inlet section. The number and arrangement of the passage openings 30 can be chosen arbitrarily within the scope of the invention.

A spring disc 34 is arranged in such a way on a downstream side of the orifice plate 26, that is to say at the bottom in FIG. 2, by means of a screw 32, that the spring disc lies opposite the downstream ends of the passage openings 30. The spring disc 34 is likewise circular. However, only part of the radius of the spring disc 34 rests flat against the underside of the orifice plate 26. The spring disc 34 is curved, wherein the convex side of the spring disc 34 faces the underside of the orifice plate 26. Within the scope of the invention, the spring disc can also be flat and can rest flat against the underside of the orifice plate. As a result, the spring disc 34 is already spaced apart from the underside of the orifice plate 26 in the region of the downstream ends of the passage openings 30. Nevertheless, the spring disc 34 represents a deflection for the liquid medium flowing through the passage openings 30, such that liquid flowing through the passage openings 30 is deflected radially outwards. A flow path through the passage openings 30 thus has a relatively small passage cross section in the state shown in FIG. 2. This passage cross section is obtained by means of the gap between the spring disc 34 and the underside of the orifice plate 26.

If, starting from the state illustrated in FIG. 2, a pressure of the liquid flowing through the passage openings 30 is then increased, the spring disc 34 is deflected downwards in FIG. 2 by the liquid impinging upon it. As a result, the distance between the spring disc 34 and the underside of the orifice plate 26 and hence the passage cross section of the flow path through the valve 24 also increases. In the case of a rise in the water pressure by 1 bar, for example, the spring disc 34 is deflected downwards by 0.5 mm. Accordingly, the passage cross section of the flow path through the valve 24 and, as a result, also the flow resistance of the valve 24 also changes.

If the liquid pressure of the liquid flowing through the passage openings 30 falls again, the spring disc 34 springs back into the position illustrated in FIG. 2. The passage cross section of the flow path through the valve 24 is thereby reduced again.

The valve 24 can be retrofitted in a very simple manner, even in existing nozzle designs. As can be seen from FIG. 1 and FIG. 2, there is an encircling shoulder 28 for the orifice plate 26 in the outlet chamber of the nozzle 10, this shoulder being used for different purposes in conventional nozzles. The orifice plate 26 can then be inserted in a very simple manner into the outlet chamber 20 of the nozzle 10, and conventional nozzles can be converted or existing forms of nozzle housings can be used.

Different characteristics of the change in the flow resistance can be achieved by changing the diameter of the passage openings 30, different positioning of the passage openings 30 relative to the spring disc 34 and changing the spring properties of the spring disc 34, for example.

1. Nozzle for spraying liquid media, in particular plant protection agents and liquid fertilizers, having a housing, wherein the housing has at least one liquid inlet, an outlet chamber and at least one outlet opening in fluid connection with the outlet chamber, wherein a valve of variable flow resistance is arranged between the liquid inlet and the outlet opening, wherein the flow resistance of the valve is dependent on the liquid pressure, wherein the valve has a spring disc, wherein the spring disc can be subjected to the liquid medium to be sprayed.

2. Nozzle according to claim 1, wherein an orifice plate having at least one passage opening is arranged in the outlet chamber, wherein the spring disc is arranged in the region of a downstream end of the passage opening.

3. Nozzle according to claim 2, wherein the spring disc is secured on a downstream side of the orifice plate and is arranged after the downstream end of the passage opening, when viewed in the flow direction through the passage opening.

4. Nozzle according to claim 1, wherein the spring disc has a curved shape, wherein a convex side of the spring disc faces the downstream end of the passage opening.

5. Nozzle according to claim 4, wherein the spring disc, in the relaxed state and without liquid passing through the passage opening applied to the spring disc, is spaced from the downstream end of the passage opening.

6. Nozzle according to claim 1, wherein the spring disc is of flat design and rests against the downstream side of the orifice plate.

7. Nozzle according to claim 1, wherein the spring disc is a metallic disc.

8. Nozzle according to claim 1, wherein an outer edge of the spring discs projects freely into the outlet chamber.

9. Nozzle according to claim 1, wherein the spring disc is clamped in a central region thereof.

10. Nozzle according to claim 1, wherein the spring disc is arranged such that a liquid medium to be sprayed is applied to the spring disc on both sides at least in sections.
